(19) United States
(12) Patent Application Publication
(10) Pub. No.: US 2016/0365763 A1
(43) Pub. Date: Dec. 15, 2016

(54) ROTOR, MOTOR, AND METHOD OF MANUFACTURING ROTOR

(71) Applicant: MABUCHI MOTOR CO., LTD., Matsudo City (JP)

(72) Inventors: Wataru Sakurai, Matsudo City (JP); Wataru Kusakabe, Matsudo City (JP)

(21) Appl. No.: 15/180,525

(22) Filed: Jun. 13, 2016

(30) Foreign Application Priority Data
Jun. 15, 2015 (JP) 2015-120498

(51) Int. Cl. H02K 1/27

(52) U.S. Cl. CPC H02K 1/2773

(57) ABSTRACT

A rotor includes: a circular rotor core in which a plurality of magnetic poles are formed in a circumferential direction on an outer circumferential surface; an auxiliary magnet placed on an axial end face of the rotor core so as to face the rotor core; a plate-shaped mounting member having a thickness t1 on which the auxiliary magnet is mounted; and a plate-shaped back yoke having a thickness t2 and placed opposite to the rotor core, sandwiching the auxiliary magnet and the mounting member.

### CROSS-REFERENCE TO RELATED APPLICATIONS

This application is based upon and claims the benefit of priority from the prior Japanese Patent Application No. 2015-120498, filed on Jun. 15, 2015, the entire content of each of which is incorporated herein by reference.

### BACKGROUND OF THE INVENTION

1. Field of the Invention

The present invention relates to rotors.

2. Description of the Related Art

In the conventional practice, motors are used as driving sources of various types of apparatuses and products. For example, the motors are used for business machines, such as printers and copying machines, various kinds of home electric appliances, and power assist sources of vehicles, such as automobiles and power-assisted bicycles. In particular, brushless motors are sometimes used as the driving sources of movable parts with high operation frequency in the light of increased durability and reduced noise.

Known as a type of such a brushless motor is an interior permanent magnet (IPM) motor where a permanent magnet is embedded in a rotor. For example, electric motors are known in which a plurality of plate-like magnets are radially embedded in a rotor yoke and the magnets are disposed such that the same poles of adjacent magnets face each other in a circumferential direction of the yoke (see, for example, patent document 1).

In these electric motors, a disc-shaped auxiliary permanent magnet and a back yoke formed of a magnetic material are provided on both axial end faces of the rotor in order to reduce the magnetic flux leaking from the magnet embedded in the rotor yoke in the axial direction.

[patent document 1] JP2014-150660

The above-mentioned auxiliary permanent magnet may be manufactured by magnetizing a component formed of a magnetic material to produce multiple magnetic poles by using the magnetizing yoke. Further, a magnetic body may be fixed to the back yoke before magnetizing the auxiliary permanent magnet in order to position the auxiliary permanent magnet to the rotor with precision.

If the auxiliary permanent magnet is manufactured by magnetizing the surface of the magnetic body fixed to the back yoke to produce multiple magnetic poles, the magnetic flux available for magnetization is reduced due to an eddy current and magnetic flux short circuit caused by the back yoke. As a result, a large magnetization current will be necessary in order to obtain desired performance. Meanwhile, in the case that an auxiliary permanent magnet magnetized in advance is fixed to the back yoke, an attractive force is exerted so that it is difficult to position the auxiliary permanent magnet with prevision, leaving room for improvement in productivity.

### SUMMARY OF THE INVENTION

The present invention addresses the aforementioned issue, and a purpose thereof is to provide a highly-productive rotor capable of exhibiting desired performance.

The rotor according to an embodiment of the present invention includes: a circular rotor core in which a plurality of magnetic poles are formed in a circumferential direction on an outer circumferential surface; an auxiliary magnet having a thickness t and placed on an axial end face of the rotor core so as to face the rotor core; a plate-shaped mounting member having a thickness t1 on which the auxiliary magnet is mounted; and a plate-shaped back yoke having a thickness t2 and placed opposite to the rotor core, sandwiching the auxiliary magnet and the mounting member.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a cross-sectional view of a brushless motor according to an embodiment;

FIG. 2 is an exploded perspective view of a rotor according to the embodiment;

FIG. 3 is a schematic diagram showing an exemplary magnetization method;

FIG. 4 is a schematic diagram illustrating the magnetization method according to the embodiment;

FIG. 5 is a side view showing that the back yoke is laminated on the Z magnet magnetized;

FIG. 6 is a schematic diagram illustrating the form of the back yoke according to variation 1;

FIG. 7 is a front view of the mounting member according to variation 2;

FIG. 8 is a front view of the mounting member according to variation 3; and

FIG. 9 is a front view of the mounting member according to variation 4.

### DETAILED DESCRIPTION OF THE INVENTION

The invention will now be described by reference to the preferred embodiments. This does not intend to limit the scope of the present invention, but to exemplify the invention.

The rotor according to an embodiment of the present invention includes: a circular rotor core in which a plurality of magnetic poles are formed in a circumferential direction on an outer circumferential surface; an auxiliary magnet having a thickness t and placed on an axial end face of the rotor core so as to face the rotor core; a plate-shaped mounting member having a thickness t1 on which the auxiliary magnet is mounted; and a plate-shaped back yoke having a thickness t2 and placed opposite to the rotor core, sandwiching the auxiliary magnet and the mounting member.

According to this embodiment, the auxiliary magnet can be magnetized while it is being mounted to the mounting member. Therefore, the thickness and material quality of the mounting member suitable for magnetization can be selected.

The thickness t1 of the mounting member may be smaller than the thickness t2 of the back yoke. This allows the auxiliary magnet to be magnetized while it is being mounted to the mounting member that is thinner than the back yoke. Accordingly, an eddy current and magnetic flux short circuiting can be reduced as compared with a case where the auxiliary magnet is fixed to the back yoke having a relatively large thickness for magnetization.

The thickness t1 of the mounting member may be less than half the thickness t of the auxiliary magnet. This can further reduce an eddy current and magnetic flux short circuiting in the mounting member. By ensuring that the thickness t1 of the mounting member to be 0.1-0.8 [mm], an eddy current and magnetic flux short circuiting in the mounting member can be further reduced.

The mounting member may be formed of a soft magnetic material. This allows the mounting member to also function as a back yoke in the rotor. Therefore, the performance of the motor will be improved by using the rotor configured in this way. The mounting member may be formed of an electromagnetic steel sheet. This reduces an eddy current generated in the mounting member, which hinders the magnetization process.

The auxiliary magnet may be a ring-shaped rare earth magnet. The magnetic coercive force of the rare earth magnet may be 1000 [A/m] or more. In order to fully magnetize a rare earth magnet having a high magnetic coercive force and extract the potential of performance thereof, a high magnetization magnetic field is needed. Therefore, the impact of an eddy current and magnetic flux short circuit occurring at the time of magnetization on the performance of the magnet is relatively larger as compared with the case of a ferrite magnet having a relatively small magnetic coercive force. It is therefore preferred to magnetize the auxiliary magnet while it is being mounted on the thin mounting member as described above in the case that a rare earth magnet having a high magnetic coercive force is used for the auxiliary magnet.

The rotor core may include a plurality of plate-shaped magnets and a plurality of magnet holders radially formed around a rotating shaft. The plate-shaped magnets may be housed in the magnet holders such that the same magnetic poles of adjacent magnets face each other in the circumferential direction of the rotor core. N poles and S poles may be alternately formed in the circumferential direction on the outer circumferential surface of the rotor core.

The auxiliary magnet may be configured such that N poles and S poles are alternately formed in the circumferential direction on a surface of the auxiliary magnet facing the axial end face of the rotor core.

Slits may be formed in the mounting member so as to be located between respective pairs of N poles and S poles of the auxiliary magnet when the auxiliary magnet is mounted to the mounting member. This can further reduce magnetic flux short circuiting in the mounting member.

A positioning mechanism that positions the rotor core and the auxiliary magnet may further be provided. A crack is easily formed in an auxiliary magnet embodied by a rare earth magnet. For this reason, the positioning mechanism may be provided in the mounting member and the back yoke instead of the auxiliary magnet, which is relatively difficult to work.

A sum of the thickness t2 of the back yoke and the thickness t1 of the mounting member may be half the thickness t of the magnet or more. This can further reduce the magnetic flux leaking from the rotor. A sum of the thickness t2 of the back yoke and the thickness t1 of the mounting member may be 1.5 times the thickness t of magnet or less. This prevents the size and weight of the rotor from being increased and reduces the magnetic flux leaking from the rotor at the same time.

A motor may comprise: a tubular stator provided with a plurality of windings; a rotor provided at a center of the stator; and a power feeder that feeds power to the plurality of windings of the stator.

Another embodiment of the present invention relates to a method of manufacturing a rotor. The method comprises: mounting and fixing a magnetic body on a mounting member having a thickness t1; forming, using a magnetizing device, an auxiliary magnet in which N poles and S poles are alternately formed in a circumferential direction on an end face of the magnet body; and laminating a plate-shaped back yoke having a thickness t2 (t2>t1) on the mounting member.

According to this embodiment, the auxiliary magnet can be magnetized while it is being mounted to the mounting member that is thinner than the back yoke. Accordingly, an eddy current and magnetic flux short circuiting are reduced, as compared with a case where the auxiliary magnet is fixed to the back yoke having a relatively large thickness for magnetization.

Optional combinations of the aforementioned constituting elements, and implementations of the invention in the form of methods, apparatuses, and systems may also be practiced as additional modes of the present invention. According to the embodiment described above, a highly-productive rotor capable of exhibiting desired performance is provided.

A description will be given of an embodiment of the present invention with reference to the drawings. Like numerals represent like elements so that the description will be omitted accordingly. The structures described below are by way of examples only and do not limit the scope of the present invention. A brushless motor of inner rotor type is described below by way of an example.

### [Brushless Motor]

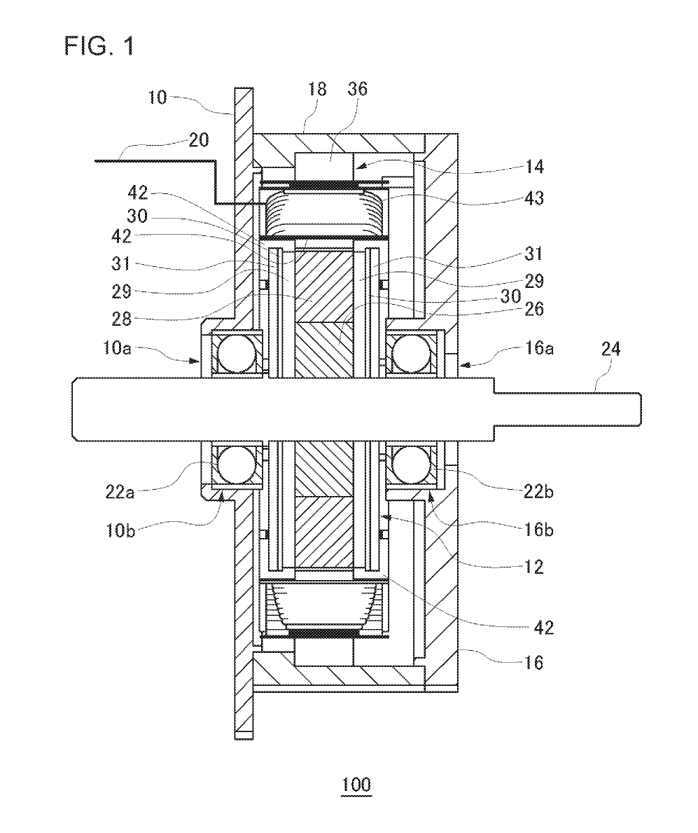

FIG. 1 is a cross-sectional view of a brushless motor according to an embodiment. A brushless motor (hereinafter, also referred to as “motor”) 100 according to the first embodiment includes a front bell 10, a rotor 12, a stator 14, an end bell 16, a housing 18, and a power feed section 20.

The front bell 10, which is a plate-shaped member, not only has a hole 10a formed in a central part so that a rotating shaft 24 can pass therethrough, but also has a recess 10b, which holds a bearing 22a, formed near the hole 10a. The end bell 16, which is a plate-shaped member, not only has a hole 16a formed in a central part so that the rotating shaft 24 can pass therethrough, but also has a recess 16b, which holds a bearing 22b, formed near the hole 16a. The housing 18 is a tubular member. The front bell 10, the end bell 16, and the housing 18 constitute a casing of a motor 100.

### [Rotor]

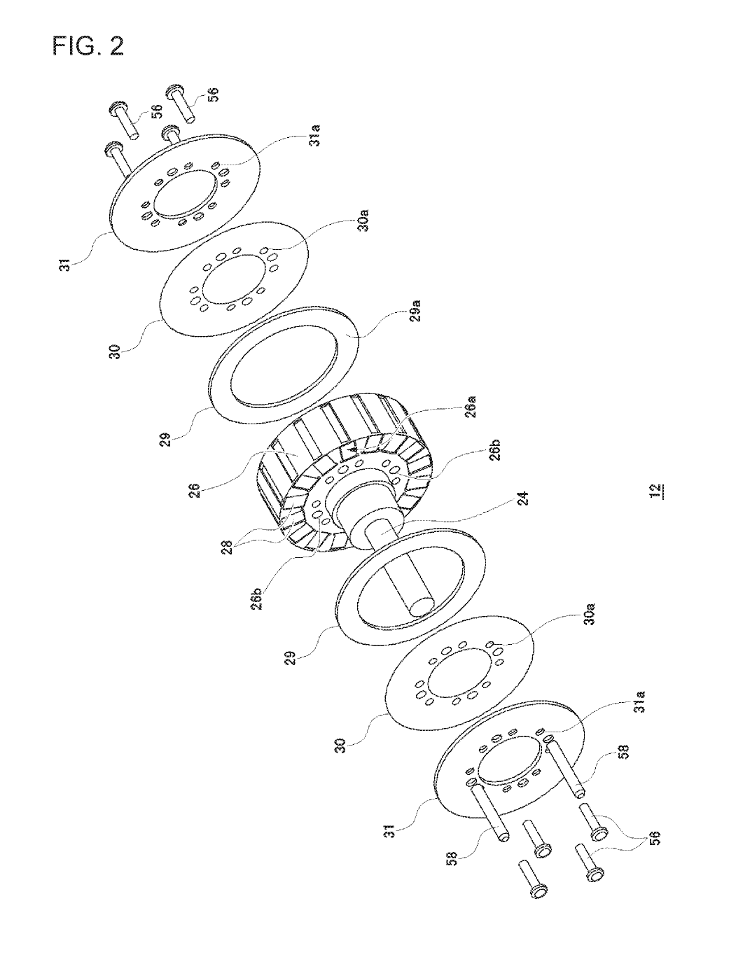

FIG. 2 is an exploded perspective view of a rotor according to the embodiment. The rotor 12 is provided with a circular rotor core 26, a plurality of θ magnets 28, a Z magnet 29 embodied by a pair of a ring-shaped auxiliary magnets placed on the axial end faces of the rotor core so as to face the rotor core 26, respectively, ring-shaped mounting members 30 adapted to fix the Z magnets at predetermined positions, respectively, during magnetization, and a ring-shaped back yoke 31. The Z magnet 29 and the mounting member 30 are adhesively fixed to each other. The Z magnet 29 and the mounting member 30 are sandwiched by the rotor core 26 and the back yoke 31.

The Z magnet 29 is configured such that N poles and S poles are alternately formed in the circumferential direction on the surface facing the axial end face of the rotor core 26 and on the opposite surface, using a magnetization method described below.

A through hole in which the rotating shaft 24 is inserted and fixed is formed at the center of the rotor core 26. Also, the rotor core 26 includes a plurality of magnet holders 26a in which the θ magnets 28 are inserted and fixed. The θ magnets 28 are members of a plate shape conforming to the shape of the magnet holders 26a.

In the rotor core 26, a plurality of plate-shaped members are laminated. Each of the plurality of plate-shaped members is manufactured by stamping out a non-oriented electromagnetic steel sheet (e.g., silicon steel sheet) or a cold-rolled steel sheet into a predetermined shape by press-forming. The magnet holders 26a are radially formed around the rotating shaft of the rotor core 26.

The θ magnets 28 are housed in the magnet holders 26a such that the same magnetic poles of adjacent θ magnets face each other in the circumferential direction of the rotor core 26. In other words, the θ magnets 28 are configured such that two principal surfaces, whose surface areas are largest among the six surfaces of each of the adjacent θ magnets 28 that are approximately rectangular parallelepipeds, are an N pole and an S pole, respectively. Thus, the lines of magnetic force emanating from the principal surfaces of the θ magnet 28 are directed outward of the rotor core 26 from a region disposed between two adjacent θ magnets 28. As a result, the rotor 12 according to the present embodiment functions as 16 magnets such that 8 N poles and 8 S poles are alternately formed in the circumferential direction on the outer circumferential surface of the rotor 12. Further, the lines of magnetic force emanating from the θ magnets 28 directed outward in the axial direction are also generated. The magnetic flux in the axial direction does not contribute to the motor performance but causes loss on the contrary. For this reason, the magnetic flux directed in the axial direction is contained by the Z magnets 29 and the back yokes 31 and is guided toward the stator 14.

The θ magnet 28 is a bonded magnet, a sintered magnet or the like, for instance. The bonded magnet is a magnet formed by kneading a magnetic material with a rubber or resin material and then subjecting the resulting material to injection molding or compression molding. Where the bonded magnet is used, a high-precision C face (inclined plane) or R face is obtained without having to perform any postprocessing. On the other hand, the sintered magnet is a magnet formed by sintering powered magnetic materials at high temperature. The sintered magnet is more likely to improve the residual magnetic flux density than the bonded magnet is. Examples of materials for the magnet include ferrite magnets and rare earth magnets.

### [Stator]

A stator core 36 of the stator 14 is a cylindrical member in which a plurality of plate-shaped stator yokes are laminated. The stator yoke is configured such that a plurality of teeth (teeth) are formed to extend from the inner circumference of the annular portion toward the center.

An insulator 42 as shown in FIG. 1 is attached to each of the teeth. Then, a conductor is wound around the insulator 42 for each of the teeth 40 so as to form a stator windings 43. Then, the rotor 12 is placed at the center of the stator 14 that has been completed through the above processes.

Thus, the motor 100 according to the embodiment includes: the tubular stator 14 where a plurality of stator windings 43 are placed; the rotor 12 provided at the center of the stator 14; and the power feed section 20 configured to supply power to the plurality of windings 43 of the stator 14.

### [Magnetization Method]

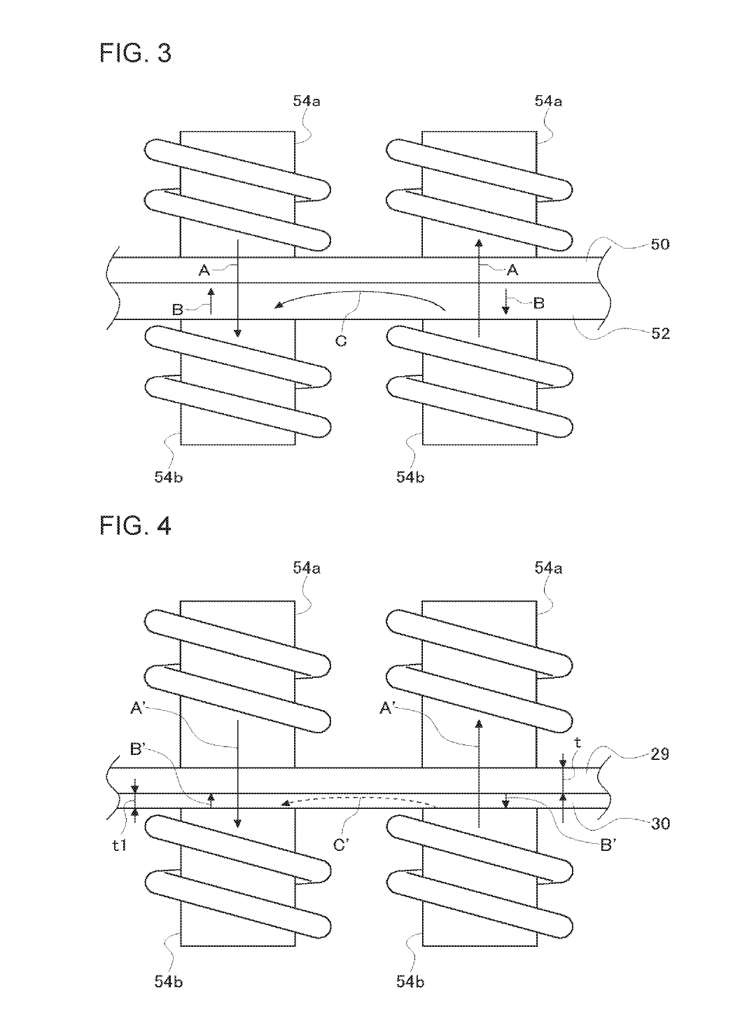

FIG. 3 is a schematic diagram showing an exemplary magnetization method. An attractive force is exerted if a Z magnet 50 is magnetized alone before being fixed to a back yoke 52. It will therefore be difficult to position the poles. One approach to address this is to fix the Z magnet 50 at a predetermined position relative to the back yoke 52 before being magnetized with precision, using a positioning means provided in the back yoke. For example, if the Z magnet 50 and the back yoke 52 are sandwiched by a plurality of pairs of magnetizing yokes 54a and 54b and an electric current is induced in the coils in order to form a large number of magnetic poles on the end face of the Z magnet 50, the magnetic flux is generated in the direction of arrow A so as to pass through the Z magnet 50 and the back yoke 52. In this process, the magnetic flux in the direction of arrow B is generated in the back yoke 52 due to an eddy current. If the magnetic pole in the Z magnet 50 formed by the adjacent magnetization yoke have the opposite polarity, a short circuit (magnetic flux short circuiting) via the back yoke 52 is generated by the magnetic flux in the direction of arrow C.

The magnetic flux generated by an eddy current and magnetic flux shorting circuit reduce the magnetic flux available for magnetization of the Z magnet 50. It is therefore desired to reduce the magnetic flux generated by an eddy current and magnetic flux short circuiting. Meanwhile, the magnetic flux of the θ magnet 28 in the axial direction needs to be reduced and directed to the stator in order to improve the motor performance. In this respect, it is preferred to provide a certain thickness of the back yoke 52.

Accordingly, the rotor according to the embodiment is configured such that the mounting member 30 having a smaller thickness than an ordinary back yoke is used for positioning and magnetization, and the back yoke 31 having a desired thickness is laminated subsequently.

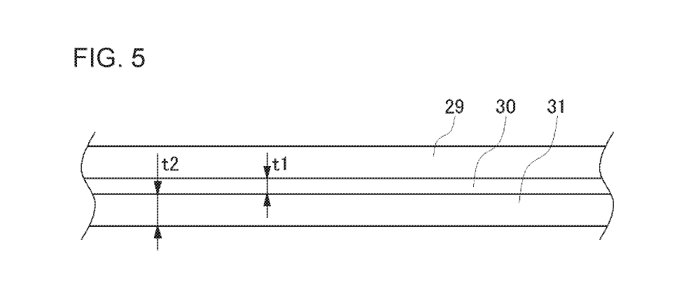

FIG. 4 is a schematic diagram illustrating the magnetization method according to the embodiment. FIG. 5 is a side view showing that the back yoke is laminated on the Z magnet magnetized.

As shown in FIG. 4, the Z magnet 29 embodied by a ring-shaped ferromagnetic body is mounted and fixed on the plate-shaped mounting member 30 having a thickness t1. The plurality of pairs of magnetizing yokes 54a and 54b are used to magnetize the Z magnet 29. In this way, the Z magnet 29 as an auxiliary magnet, in which N poles and S poles are alternately formed in the circumferential direction, is formed on the end face of the ferromagnetic body. As shown in FIG. 5, the plate-shaped back yoke 31 having a thickness t2 is then laminated on the mounting member 30.

The magnetization method according to the embodiment can magnetize the Z magnet 29 mounted on the mounting member 30 to have desired performance by configuring the mounting member 30 to have a thickness and material quality suitable for magnetization.

The thickness t1 of the mounting member 30 is smaller than the thickness t2 of the back yoke 31. This allows the Z magnet 29 to be magnetized while it is being mounted to the mounting member 30 thinner than the back yoke 31. Thus, given that the mounting member 30 is formed of a magnetic metal, the magnetic flux generated by an eddy current (magnetic flux in the direction B′ shown in FIG. 4) and magnetic flux short circuiting (magnetic flux in the direction of arrow C′ shown in FIG. 4) are reduced, as compared with a case where the Z magnet 29 is fixed to the back yoke having a relatively large thickness for magnetization. As a result, the magnetic flux in the direction of arrow A′ generated to pass through the Z magnet 50 and the back yoke 52 is increased so that the Z magnet 29 is formed to have more powerful magnetic force. In other words, a magnetizing yoke of a smaller size can be used for magnetization for the purpose of obtaining the Z magnet 29 having a given magnetic force so that it is easy to manufacture the Z magnet 29 having a larger number of magnetic poles. In the case that the mounting member 30 is formed of a non-magnetic metal, the magnetic flux generated by an eddy current is reduced and a magnetic flux short circuit does not occur, as compared with a case where the Z magnet 29 is fixed to a thicker back yoke for magnetization.

In the case that a non-magnetic non-metallic material (e.g., a resin material such as polyamide) is used for the mounting member 30, an eddy current or a magnetic flux short circuit is not generated when the Z magnet 29 is magnetized, but the Z magnet 29 and the magnetizing yoke can be placed in close proximity to each other by ensuring that the thickness t1 of the mounting member is smaller than the thickness t2 of the back yoke 31. Therefore, the leaking magnetic flux is reduced and the Z magnet 29 is magnetized to have desired performance. Further, the Z magnet 29 and the back yoke 31 are placed in close proximity to each other after the motor is assembled. Accordingly, the motor performance is improved.

As shown in FIGS. 1 and 2, the rotor 12 is provided with the circular rotor core 26 in which a plurality of magnetic poles are formed in the circumferential direction on the outer circumferential surface, the ring-shaped Z magnets 29 placed on the axial end faces of the rotor core 26 so as to face the rotor core 26, respectively, the plate-shaped mounting members 30 having the thickness t1 on which the Z magnets 29 are respectively mounted, and the plate-shaped back yokes 31 placed opposite to the rotor core 26, respectively sandwiching the Z magnet 29 and the mounting member 30 in between, and having the thickness t2.

The mounting member 30 is required have a thickness within a range capable of maintaining the shape of the mounting member 30 when the Z magnet 29 is mounted thereon. More specifically, it is preferred that the thickness t1 of the mounting member 30 is less than half the thickness t of the Z magnet 29. More preferably, the thickness t1 is in a range 0.1-0.8 [mm]. Still more preferably, the thickness t1 is less than 0.4 mm. This can reduce an eddy current and magnetic flux short circuiting in the mounting member 30 in the case that the mounting member 30 is formed of a magnetic metal. In the case that the mounting member 30 is formed of a non-magnetic metal, an eddy current generated in the mounting member 30 is further reduced. In the case that the mounting member 30 is formed of a non-magnetic material, the motor performance is improved by allowing the magnet and the back yoke to be placed in close proximity to each other. A sum of the thickness t2 of the back yoke 31 and the thickness t1 of the mounting member 30 may be half the thickness t of the Z magnet 29 or more. This can further reduce the magnetic flux leaking from the rotor. A sum of the thickness t2 of the back yoke 31 and the thickness t1 of the mounting member 30 may be 1.5 times the thickness t of the Z magnet 29 or less. This prevents the size and weight of the rotor from being increased and reduces the magnetic flux leaking from the rotor at the same time.

The mounting member 30 may alternatively be formed of a soft magnetic material. This allows the mounting member 30 to also function as a back yoke in the rotor 12. The performance of the motor 100 is improved by using the rotor 12 configured in this way. Still alternatively, the mounting member 30 may be formed of electromagnetic steel. This reduces an eddy current generated in the mounting member 30, which hinders the magnetization process.

Because the Z magnet 29 according to the embodiment is a ring-shaped rare earth magnet, a crack is easily formed. It is therefore difficult to work the magnet to form projections or holes for positioning. According to the magnetization method of the embodiment, however, the Z magnet 29 is mounted and fixed on the mounting member 30 before magnetization so that the positioning mechanism may be provided in the mounting member 30 and the Z magnet 29 need not be worked into a complex form. Further, since the mounting member 30 can be implemented by a member that is relatively easy to work (e.g., electromagnetic steel), productivity of the rotor is improved.

In the case of a rare earth magnet, it is preferred that the magnetic coercive force be 1000 [A/m] or more. In order to extract the potential of performance of a rare earth magnet having such a high magnetic coercive force, a high magnetization magnetic field is needed. Therefore, the impact of an eddy current and magnetic flux short circuit occurring at the time of magnetization on the performance of the magnet is relatively larger as compared with the case of a ferrite magnet having a relatively small magnetic coercive force. In the case that a rare earth magnet having a high magnetic coercive force is used for the Z magnet 29, the magnetic force of the Z magnet 29 as magnetized will be even greater, by magnetizing the Z magnet 29 while it is being mounted on the thin mounting member 30 described above.

The rotor 12 is further provided with a positioning mechanism for positioning the rotor core 26 and the Z magnet 29. As described above, a crack is easily formed in the Z magnet 29 implemented by a rare earth magnet. For this reason, the positioning mechanism is provided in the mounting member 30 and the back yoke 31 instead of the Z magnet 29, which is relatively difficult to work. More specifically, the positioning mechanism is provided with a plurality of holes 26b formed in the cylindrical part inside the magnet holders 26a of the rotor core 26, a plurality of holes 30a formed in the mounting member 30, a plurality of holes 31a formed in the back yoke 31, a plurality of fastening screws 56, and a plurality of positioning pins 58.

The fastening screw 56 passes through a predetermined hole 31a of the back yoke 31 and a predetermined hole 30a of the mounting member 30 and is driven into the hole 26b of the rotor core 26. The positioning pin 58 is inserted into some of the holes 31a and the holes 30a in which the fastening screw 56 is not inserted so as to position the mounting member 30 and the back yoke 31 relative to the rotor core 26. This positions the mounting member 30 on which the Z magnet is mounted, the back yoke 31, and the rotor core 26 relative to each other.

### (Variation 1)

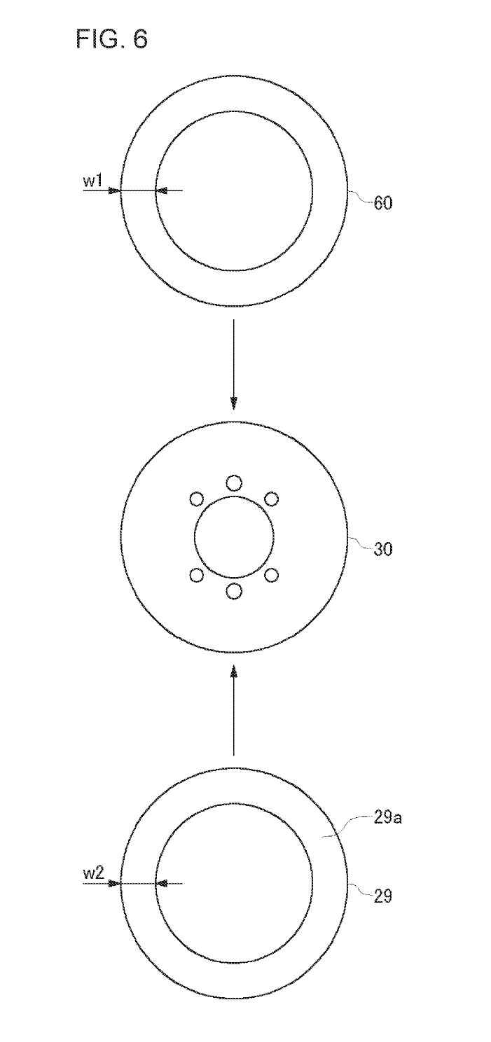

In the rotor 12 shown in FIG. 2, the mounting member 30 and the back yoke 31 have substantially the same form except for the thickness. However, the back yoke 31 need only have a width equal to that of an end face 29a of the Z magnet 29 in order to provide the necessary function. FIG. 6 is a schematic diagram illustrating the form of the back yoke according to variation 1.

A back yoke 60 is a ring-shaped member. A width W1 of an annular end face 60a is substantially equal to a width W2 of the annular end face 29a of the Z magnet 29. Alternatively, the width W1 of the annular end face 60a may be larger than the width W2 of the annular end face 29a of the Z magnet 29. The Z magnet 29 and the back yoke 60 are fixed to predetermined positions on the mounting member 30 by using an adhesive.

### (Variation 2)

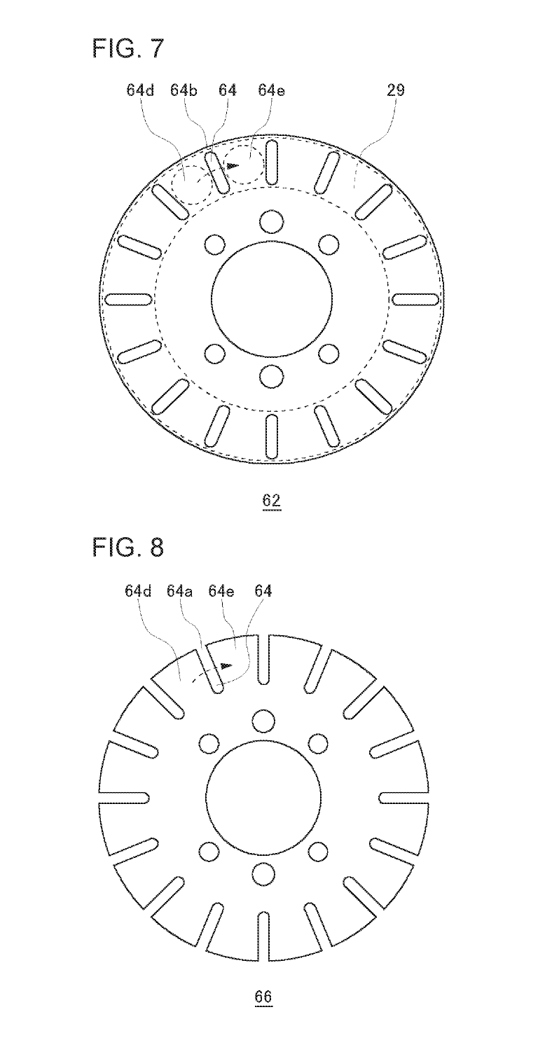

FIG. 7 is a front view of the mounting member according to variation 2; Slits 64 are formed in the mounting member 62 shown in FIG. 7 so as to be located between respective pairs of N poles (magnetic pole 64d) and S poles (magnetic pole 64e) of the Z magnet when the Z magnet 29 is mounted to the mounting member 62. By forming the slits 64, the magnetic flux passing through the slits 64 is reduced so that magnetic flux shorting during magnetization is reduced.

### (Variation 3)

FIG. 8 is a front view of the mounting member according to variation 3. The slits 64 of a mounting member 66 shown in FIG. 8 extend to the outer circumferential part due to cut-out parts 64a. Therefore, as compared with the mounting member 62 shown in FIG. 7, the magnetic flux directed from a given magnetic pole 64d toward an adjacent magnetic pole 64e via a connecting part 64b in the outer circumferential part is reduced so that magnetic flux short circuiting during magnetization is reduced.

### (Variation 4)

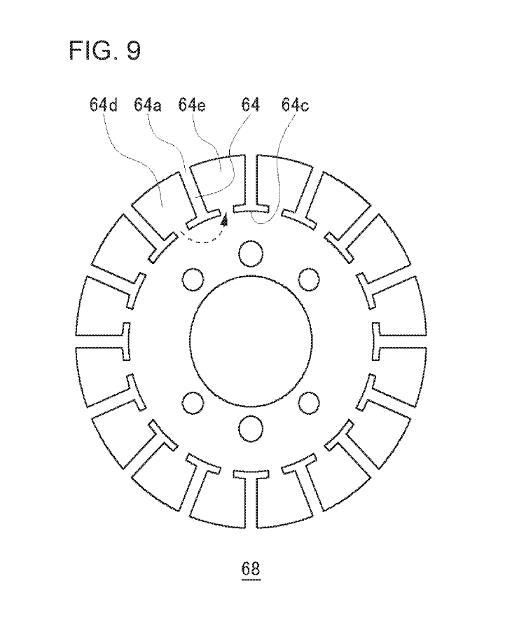

FIG. 9 is a front view of the mounting member according to variation 4. In addition to the cut-out parts 64a, a mounting member 68 shown in FIG. 9 is formed with circumferential slits 64c at the respective ends of the slits 64 toward the central axis. This narrows the magnetic path directed from the magnetic pole 64d toward the adjacent magnetic pole 64e. Therefore, as compared with the mounting member 66 shown in FIG. 8, the magnetic flux directed from the magnetic pole 64d toward the adjacent magnetic pole 64e via the inner circumferential part is reduced so that magnetic flux short circuiting during magnetization is reduced.

As described above, the mounting member 30 of the rotor according to the embodiment is configured to be thin so that a large magnetization effect is achieved by a small magnetization current when the mounting member 30, which can be a back yoke, is mounted to the ring-shaped Z magnet 29. Meanwhile, the thin mounting member 30 alone results in reduced magnetic flux available for the motor so that the back yoke 31 is additionally laminated when the motor is assembled.

Positioning of the Z magnet relative to the rotor core carries weight. Therefore, one approach would be to provide the back yoke itself with a positioning mechanism. In this case, the Z magnet is fixed to the back yoke and is magnetized using the positioning mechanism to position the Z magnet. The Z magnet is fitted to the rotor core, maintaining the positioning thus established. However, the magnetization magnetic flux is reduced due to a magnetic flux short circuit or eddy current generated in the back yoke, in the case that a high-grade (high magnetic force) magnet is magnetized to produce a large number of magnetic poles. Therefore, a large magnetizing current is necessary in order to obtain necessary magnetization effect. Depending on the magnet grade, the lack of capability of the magnetizing yoke according to the related art resulted in failure to magnetize the magnet properly.

This is addressed by the magnetization method according to the embodiment by enabling multiple-pole magnetization of a high-grade magnet with a relatively small current. Accordingly, a high-grade magnet can be used as a Z magnet. It should also be noted that the Z magnet according to the embodiment is not magnetized before being mounted to the mounting member and so is easy to use as a component. Thus, the rotor and the method of manufacturing the rotor according to the embodiment improve the productivity significantly. By using a high-grade magnet as a Z magnet, flat, compact, high-output motors can be realized.

The embodiments of the present invention are not limited to those described above and appropriate combinations or replacements of the features of the embodiments (e.g., motors of outer rotor structure) are also encompassed by the present invention. The embodiments may be modified by way of combinations, rearranging of the processing sequence, design changes, etc., based on the knowledge of a skilled person, and such modifications are also within the scope of the present invention.

1. A rotor comprising:
a circular rotor core in which a plurality of magnetic poles are formed on a circumferential end face;
an auxiliary magnet placed on an axial end face of the rotor core so as to face the rotor core;
a plate-shaped mounting member having a thickness t1 on which the auxiliary magnet is mounted; and
a plate-shaped back yoke having a thickness t2 and placed opposite to the rotor core, sandwiching the auxiliary magnet and the mounting member.

2. The rotor according to claim 1, wherein
the thickness t1 of the mounting member is smaller than the thickness t2 of the back yoke.

3. The rotor according to claim 1, wherein
the mounting member is formed of an electromagnetic steel sheet.

4. The rotor according to claim 1, wherein
the magnetic coercive force of the auxiliary magnet is 1000 [A/m] or more.

5. The rotor according to claim 1, wherein
the rotor core includes a plurality of plate-shaped magnets and a plurality of magnet holders radially formed around a rotating shaft,
the plate-shaped magnets are housed in the magnet holders such that the same magnetic poles of adjacent magnets face each other in the circumferential direction of the rotor core, and
N poles and S poles are alternately formed in the circumferential direction on the outer circumferential surface of the rotor core.

6. The rotor according to claim 1, wherein
the auxiliary magnet is configured such that N poles and S poles are alternately formed in the circumferential direction on a surface of the auxiliary magnet facing the axial end face of the rotor core.

7. The rotor according to claim 6, wherein
slits are formed in the mounting member so as to be located between respective pairs of N poles and an S poles of the auxiliary magnet when the auxiliary magnet is mounted to the mounting member.

8. The rotor according to claim 1, further comprising:
a positioning mechanism that positions the rotor core and the auxiliary magnet.

9. A motor comprising:
a tubular stator provided with a plurality of windings;
the rotor according to claim 1 provided at a center of the stator; and
a power feeder that feeds power to the plurality of windings of the stator.

10. The rotor according to claim 2, wherein
the rotor core includes a plurality of plate-shaped magnets and a plurality of magnet holders radially formed around a rotating shaft,
the plate-shaped magnets are housed in the magnet holders such that the same magnetic poles of adjacent magnets face each other in the circumferential direction of the rotor core, and
N poles and S poles are alternately formed in the circumferential direction on the outer circumferential surface of the rotor core.

11. The rotor according to claim 10, wherein
the auxiliary magnet is configured such that N poles and S poles are alternately formed in the circumferential direction on a surface of the auxiliary magnet facing the axial end face of the rotor core.

12. A method of manufacturing a rotor, comprising:
mounting and fixing a magnetic body on a mounting member having a thickness t1;
forming, using a magnetizing device, an auxiliary magnet in which N poles and S poles are alternately formed in a circumferential direction on an end face of the magnet body; and
laminating a plate-shaped back yoke having a thickness t2 (t2>t1) on the mounting member.
